(19) United States
(12) Patent Application Publication
(10) Pub. No.: US 2017/0129177 A1
(43) Pub. Date: May 11, 2017

(54) USE OF THERMOPLASTIC POLYURETHANE POWDERS

(71) Applicants: COVESTRO DEUTSCHLAND AG, Leverkusen (DE); LEHMANN & VOSS & CO KG, Hamburg (DE)

(72) Inventors: Jürgen Hättig, Odenthal (DE); Peter Reichert, Dormagen (DE); Marcus Rechberger, Hamburg (DE)

(21) Appl. No.: 15/321,130

(22) PCT Filed: Jun. 22, 2015
(86) PCT No.: PCT/EP2015/063916

§ 371 Date: Dec. 21, 2016

(30) Foreign Application Priority Data
Jun. 23, 2014 (EP) 14173556.3

(51) Int. Cl. B29C 67/00; B33Y 10/00; C08G 18/66; C08G 18/76; C08G 18/32; C08G 18/42; B33Y 70/00; C08K 3/36

(52) U.S. Cl. CPC B29C 67/0077; B33Y 70/00; B33Y 10/00; C08K 3/36; C08G 18/7671; C08G 18/3206; C08G 18/4238; C08G 18/664; B29K 2075/00

(57) ABSTRACT

The present invention relates to the use of thermoplastic polyurethane powders in powder-based additive manufacturing methods for the production of elastic articles.

The present invention relates to the use of thermoplastic polyurethane powders in powder-based additive manufacturing processes for producing thermoplastic objects.

For the purposes of the present invention, additive manufacturing processes are processes by means of which objects are built up in layers. They are therefore clearly different from other processes for producing objects, e.g. milling, drilling, cutting machining. In the latter processes, an object is worked in such a way that it attains its final geometry by removal of material.

Additive manufacturing processes utilize various materials and process techniques in order to build up objects in layers. In fused deposition modeling (FDM), for example, a thermoplastic polymer wire is liquefied and deposited in layers by means of a nozzle on a movable building platform. On solidification, a solid object is formed. Control of the nozzle and the building platform is effected on the basis of a CAD drawing of the object. If the geometry of this object is complex, e.g. with geometric undercuts, support materials have to be additionally printed and removed again after the object has been finished.

In addition, there are additive manufacturing processes which utilize thermoplastic powders in order to build up objects in layers. Here, thin powder layers are applied by means of a coater and subsequently selectively melted by means of an energy source. The surrounding powder supports the component geometry in this case. Complex geometries are more economical to produce in this way than by the FDM process described. In addition, various objects can be arranged or produced closely packed in the powder bed. Owing to these advantages, powder-based additive manufacturing processes are among the most economical additive processes on the market. They are therefore predominantly employed by industrial users.

Examples of powder-based additive manufacturing processes are laser sintering or high speed sintering (HSS). They differ from one another in the method of introducing energy for selective melting into the polymer. In the laser sintering process, the energy is introduced by means of a guided laser beam. In the high speed sintering (HSS) process (EP 1648686 B), the introduction of energy is effected by means of infrared (IR) lamps in combination with an IR absorber selectively printed into the powder bed. Selective heat sintering (SHS™) utilizes the printing unit of a conventional thermal printer in order to melt thermoplastic powders selectively.

Laser sintering in particular has been established in industry for many years and is utilized primarily for producing prototypes. However, although it has been announced for years by the media, companies and the research institutes active in this field, it has not become established on the market as process for the mass production of individually configured products. One of the significant reasons for this is the available materials and their properties. Objects whose mechanical properties differ fundamentally from the characteristics of the materials as are known in other polymer-processing processes, for example injection molding, are formed on the basis of the polymers which are used today in powder-based additive manufacturing processes. During processing by the additive manufacturing processes, the thermoplastic materials used lose their specific characteristics.

Polyamide 12 (PA12) is the mostly widely used material at present for powder-based additive manufacturing processes, e.g. laser sintering. PA12 displays high strength and toughness when it is processed by injection molding or by extrusion. A commercial PA12 displays, for example, an elongation at break of more than 200% after injection molding. PA12 objects which have been produced by the laser sintering process, on the other hand, display elongations at break of about 15%. The component is brittle and can therefore no longer be considered to be a typical PA12 component. The same applies to polypropylene (PP) which is offered as powder for laser sintering. This material, too, becomes brittle and thus loses the tough and resilient properties typical of PP. The reasons for this lie in the morphology of the polymers.

During melting by means of laser or IR and especially during cooling, an irregular internal structure of partially crystalline polymers (for example PA12 and PP) arises. The internal structure (morphology) of partially crystalline polymers is partly characterized by high order. A certain proportion of the polymer chains forms crystalline, closely packed structures during cooling. During melting and cooling, these crystallites grow irregularly at the boundaries of the not completely melted particles and at the former grain boundaries of the powder particles and at additives present in the powder. The irregularity of the morphology formed in this way aids the formation of cracks under mechanical stress. The unavoidable residual porosity in powder-based additive processes promotes cracked growth. Brittle properties of the components formed in this way are the result. For an explanation of these effects, reference is made to European Polymer Journal 48 (2012), pages 1611-1621.

The elastic polymers based on block copolymers used in laser sintering also display a property profile which is atypical of the polymers used when they are processed as powders by means of additive manufacturing processes to produce objects. Thermoplastic elastomers (TPE) are used today in laser sintering. Objects which have been produced from the TPEs available today have a high residual porosity after solidification and the original strength of the TPE material is no longer able to be measured in the object produced therefrom. In practice, these porous components are therefore infiltrated afterward with liquid, curing polymers in order to set the required property profile. The strength and elongation remain at a low level despite this additional measure. The additional process complication leads not only to still unsatisfactory mechanical properties but to poor economics of these materials.

The problem addressed by the present invention was therefore to provide compositions which, after processing by means of powder-based additive manufacturing processes, give objects which have good mechanical properties.

This problem has been able to be solved by the compositions of the invention comprising thermoplastic polyurethane powders and plasticizers and the use of these compositions in powder-based additive manufacturing processes for producing thermoplastic objects.

The invention provides thermoplastic pulverulent compositions containing from 0.02 to 0.5% by weight, based on the total amount of composition, of plasticizers and pulverulent thermoplastic polyurethane (pulverulent TPU), where at least 90% by weight of the composition has a particle diameter of less than 0.25 mm, preferably less than 0.2 mm, particularly preferably less than 0.15 mm, and the thermoplastic polyurethane is obtainable from the reaction of the components
a) at least one organic diisocyanate
b) at least one compound having groups which are reactive toward isocyanate groups and a number average molecular weight (Mn) of from 500 g/mol to 6000 g/mol and a number average functionality of the totality of the components under b) of from 1.8 to 2.5
c) at least one chain extender having a number average molecular weight (Mn) of from 60 to 450 g/mol and a number average functionality of the totality of the chain extenders under c) of from 1.8 to 2.5
in the presence of
d) optionally catalysts
e) optionally auxiliaries and/or additives
f) optionally chain termination agents,
characterized in that the thermoplastic polyurethane has a melting range (DSC, differential scanning calorimetry; 2nd heating at a heating rate of 5 K/min.) of from 20° C. to 170° C. and has a Shore A hardness (DIN ISO 7619-1) of from 50 to 95 and at a temperature T has a melt volume rate (MVR) in accordance with ISO 1133 of from 5 to 15 cm³/10 min and a change in the MVR when increasing this temperature T by 20° C. of less than 90 cm³/10 min, preferably less than 70 cm³/10 min, particularly preferably less than 50 cm³/10 min,
for producing articles in powder-based additive manufacturing processes.

In the DSC measurement, the material is subjected to the following temperature cycle: 1 minute at minus 60° C., then heating to 200° C. at 5 kelvin/minute, then cooling to minus 60° C. at 5 kelvin/minute, then 1 minute at minus 60° C., then heating to 200° C. at 5 kelvin/minute.

The thermoplastic polyurethane powder has a flat melting behavior. The melting behavior is determined via the change in the MVR (melt volume rate) in accordance with ISO 1133 at 5 minutes preheated time and 10 kg as a function of the temperature. A melting behavior is considered to be “flat” when the MVR at an initial temperature Tₓ has an initial value of from 5 to 15 cm³/10 min and this value does not increase by more than 90 cm³/10 min when the temperature is increased by 20° C. to Tₓ₊₂₀.

The invention further provides for the use of the compositions of the invention in powder-based additive manufacturing processes for producing thermoplastic objects.

The invention further provides thermoplastic objects produced by means of powder-based additive manufacturing processes from the compositions of the invention.

The thermoplastic composition of the invention is suitable for processing by means of powder-based additive manufacturing processes and the objects produced therewith have a good mechanical property profile. Thus, for example, the ultimate tensile strength of the objects is >10 MPa at an elongation at break of >400%.

The property profile of the objects produced using the thermoplastic compositions of the invention is characterized, in particular, by high strength combined with high elongation and thus by great elasticity and toughness. Powder-based additive manufacturing processes, e.g. laser sintering or high speed sintering (HSS), can be used for processing the compositions of the invention. The good mechanical property profile is achieved without additional after-treatment steps. The TPU powders used according to the invention thus allow the additive production of objects having mechanical properties which could hitherto not be achieved by means of these processes. This has surprisingly been achieved by the thermoplastic polyurethanes used according to the invention, which have a flat melting behavior.

The chemical make-up of the thermoplastic polyurethanes (TPU) used is known per se and described, for example, in EP-A 1068250. They are multiphase systems consisting of block copolymers based on one or more relatively long-chain polyols and one or more short-chain isocyanate-reactive compounds and various additives together with organic diisocyanates.

The TPU powder is preferably produced by mechanical comminution of pellets, with the pellets being cooled to a very low temperature by means of liquid nitrogen/liquid air. At least 90% of the powder should have a particle diameter of less than 0.25 mm, preferably less than 0.2 mm, particularly preferably less than 0.15 mm. Commercially available fluidizers, for example, are mixed into the TPU powder produced, which ensures that the TPU powder is free-flowing.

The TPUs used display a hardness of less than 95 Shore A and a low melting range and a flat melting behavior.

The composition can, as a result of the abovementioned properties of the TPU, be processed even at low building space temperatures and leads, for example under the conditions customary in laser sintering, to comparatively homogeneous parts which have a low residual porosity and display good mechanical properties.

The objects according to the invention which have been produced by means of powder-based additive manufacturing processes from the compositions of the invention display a high tensile strength combined with a high elongation at break. These properties have hitherto not been able to be achieved by means of additive manufacture using other materials. This includes materials which are processed to produce objects by means of additive manufacturing processes which are not powder-based.

### Production of the Thermoplastic Polyurethane (TPU)

To synthesize the TPU for production of the composition of the invention, specific mention may be made by way of example as isocyanate component under a): aliphatic diisocyanates such as ethylene diisocyanate, tetramethylene 1,4-diisocyanate, hexamethylene 1,6-diisocyanate, dodecane 1,12-diisocyanate, cycloaliphatic diisocyanates such as isophorone diisocyanate, cyclohexane 1,4-diisocyanate, 1-methylcyclohexane 2,4-diisocyanate and 1-methylcyclohexane 2,6-diisocyanate and also the corresponding isomer mixtures, dicyclohexylmethane 4,4′-diisocyanate, dicyclohexylmethane 2,4′-diisocyanate and dicyclohexylmethane 2,2′-diisocyanate and also the corresponding isomer mixtures, also aromatic diisocyanates such as tolylene 2,4-diisocyanate, mixtures of tolylene 2,4-diisocyanate and tolylene 2,6-diisocyanate, diphenylmethane 4,4′-diisocyanate, diphenylmethane 2,4′-diisocyanate and diphenylmethane 2,2′-diisocyanate. Mixtures of diphenylmethane 2,4′-diisocyanate and diphenylmethane 4,4′-diisocyanate, urethane-modified liquid diphenylmethane 4,4′-diisocyanates or diphenylmethane 2,4′-diisocyanates, 4,4′-diisocyanato-1,2-diphenylethane and naphthylene 1,5-diisocyanate. Preference is given to using hexamethylene 1,6-diisocyanate, cyclohexane 1,4-diisocyanate, isophorone diisocyanate, dicyclohexylmethane diisocyanate, diphenylmethane diisocyanate isomer mixtures having a diphenylmethane 4,4′-diisocyanate content of more than 96% by weight and in particular diphenylmethane 4,4′-diisocyanate and naphthylene 1,5-diisocyanate. The diisocyanates mentioned can be employed either individually or in the form of mixtures with one another. They can also be used together with up to 15 mol% (calculated on the basis of total diisocyanate) of a polyisocyanate, but the amount of polyisocyanate added must be such that a thermoplastically processable product is still formed. Examples of polyisocyanates are triphenylmethane 4,4′,4″-triisocyanate and polyphenylpolymethylene polyisocyanates.

As relatively long-chain isocyanate-reactive compounds under b), mention may be made by way of example of ones having an average of from at least 1.8 to 3.0 Zerewitinoff-active hydrogen atoms and a number average molecular weight of from 500 to 10 000 g/mol. These include compounds bearing not only amino groups but also thiol groups or carboxyl groups, in particular compounds having from two to three, preferably two, hydroxyl groups, especially those having number average molecular weights Mn of from 500 to 6000 g/mol, particularly preferably those having a number average molecular weight Mn of from 600 to 4000 g/mol, e.g. hydroxyl-containing polyester polyols, polyether polyols, polycarbonate polyols and polyester polyamides.

Suitable polyether diols can be prepared by reacting one or more alkylene oxides having from 2 to 4 carbon atoms in the alkylene radical with a starter molecule containing two active hydrogen atoms in bonded form. As alkylene oxides, mention may be made of, for example: ethylene oxide, 1,2-propylene oxide, epichlorohydrin and 1,2-butylene oxide and 2,3-butylene oxide. Ethylene oxide, propylene oxide and mixtures of 1,2-propylene oxide and ethylene oxide are preferably employed. The alkylene oxides can be used individually, alternately in succession or as mixtures. Possible starter molecules are, for example: water, amino alcohols such as N-alkyldiethanolamines, for example N-methyldiethanolamine, and diols such as ethylene glycol, 1,3-propylene glycol, 1,4-butanediol and 1,6-hexanediol. Mixtures of starter molecules can optionally also be used. Further suitable polyether diols are the hydroxyl-containing polymerization products of tetrahydrofuran. It is also possible to use trifunctional polyethers in proportions of from 0 to 30% by weight, based on the bifunctional polyether diols, but at most in such an amount that a thermoplastically processable product is still formed. The substantially linear polyether diols preferably have number average molecular weights n of from 500 to 6000 g/mol. They can be employed either individually or in the form of mixtures with one another.

Suitable polyester diols can, for example, be prepared from dicarboxylic acids having from 2 to 12 carbon atoms, preferably 4 to 6 carbon atoms, and polyhydric alcohols. Possible dicarboxylic acids are, for example: aliphatic dicarboxylic acids such as succinic acid, glutaric acid, adipic acid, suberic acid, azelaic acid and sebacic acid or aromatic dicarboxylic acids such as phthalic acid, isophthalic acid and terephthalic acid. The dicarboxylic acids can be used either individually or as mixtures, e.g. in the form of a succinic acid, glutaric acid and adipic acid mixture. To prepare the polyester diols, it may be advantageous to use the corresponding dicarboxylic acid derivatives such as carboxylic diesters having from 1 to 4 carbon atoms in the alcohol radical, carboxylic anhydrides or carboxylic acid chlorides instead of the dicarboxylic acids. Examples of polyhydric alcohols are glycols having from 2 to 10, preferably from 2 to 6, carbon atoms, e.g. ethylene glycol, diethylene glycol, 1,4-butanediol, 1,5-pentanediol, 1,6-hexanediol, 1,10-decanediol, 2,2-dimethylpropane 1,3-diol, 1,3-propanediol or dipropylene glycol. Depending on the desired properties, the polyhydric alcohols can be used either alone or in admixture with one another. Esters of carbonic acid with the abovementioned diols, in particular those having from 4 to 6 carbon atoms, e.g. 1,4-butanediol or 1,6-hexanediol, condensation products of w-hydroxycarboxylic acids such as w-hydroxycaproic acid or polymerization products of lactones, e.g. optionally substituted w-caprolactones, are also suitable. Polyester diols which are preferably used are ethanediol polyadipates, 1,4-butanediol polyadipates, ethanediol-1,4-butanediol polyadipates, 1,6-hexanediol-neopentyl glycol polyadipates, 1,6-hexanediol-1,4-butanediol polyadipates and polycaprolactones. The polyester diols preferably have number average molecular weights Mn of from 450 to 6000 g/mol and can be employed either individually or in the form of mixtures with one another.

The chain extenders under c) have an average of from 1.8 to 3.0 Zerewitinoff-active hydrogen atoms and have a molecular weight of from 60 to 450 g/mol. These are compounds having not only amino groups but also thiol groups or carboxyl groups, including those having from two to three, preferably two, hydroxyl groups.

As chain extenders, preference is given to using aliphatic diols having from 2 to 14 carbon atoms, e.g. ethanediol, 1,2-propanediol, 1,3-propanediol, 1,4-butanediol, 2,3-butanediol, 1,5-pentanediol, 1,6-hexanediol, diethylene glycol and dipropylene glycol. However, diesters of terephthalic acid with glycols having from 2 to 4 carbon atoms, e.g. bis(ethylene glycol) terephthalate or bis-1,4-butanediol terephthalate, hydroxyalkylene ethers of hydroquinone, e.g. 1,4-di(b-hydroxyethyl)hydroquinone, ethoxylated bisphenols, e.g. 1,4-di(b-hydroxyethyl)bisphenol A, (cyclo)aliphatic diamines such as isophoronediamine, ethylenediamine, 1,2-propylenediamine, 1,3-propylenediamine, N-methylpropylene-1,3-diamine, N,N′-dimethylethylenediamine, and aromatic diamines such as 2,4-toluenediamine, 2,6-toluenediamine, 3,5-diethyl-2,4-toluenediamine or 3,5-diethyl-2,6-toluenediamine or primary monoalkyl-, dialkyl-, trialkyl- or tetraalkyl-substituted 4,4′-diaminodiphenylmethanes are also suitable. Particular preference is given to using ethanediol, 1,4-butanediol, 1,6-hexanediol, 1,4-di(β-hydroxyethyphydroquinone or 1,4-di(β-hydroxyethyl)-bisphenol A as chain extenders. It is also possible to use mixtures of the abovementioned chain extenders.

In addition, relatively small amounts of triols can also be added.

Compounds which are monofunctional toward isocyanates can be used as chain termination agents under f) in amounts of up to 2% by weight, based on TPU. Suitable compounds of this type are, for example, monoamines such as butylamine and dibutylamine, octylamine, stearylamine, N-methylstearylamine, pyrrolidine, piperidine or cyclohexylamine, monoalcohols such as butanol, 2-ethylhexanol, octanol, dodecanol, stearyl alcohol, the various amyl alcohols, cyclohexanol and ethylene glycol monomethyl ether.

The substances which are reactive toward isocyanate should preferably be selected so that their number average functionality does not significantly exceed two when thermoplastically processable polyurethane elastomers are to be produced. If higher-functionality compounds are used, the overall functionality should be reduced accordingly by means of compounds having a functionality of <2.

The relative amounts of isocyanate groups and groups which are reactive toward isocyanate are preferably selected so that the ratio is from 0.9:1 to 1.2:1, preferably from 0.95:1 to 1.1:1.

The thermoplastic polyurethane elastomers used according to the invention can contain, as auxiliaries and/or additives, up to a maximum of 20% by weight, based on the total amount of TPU, of the customary auxiliaries and additives. Typical auxiliaries and additives are catalysts, antiblocking agents, inhibitors, pigments, dyes, flame retardants, stabilizers against aging and weathering influences, against hydrolysis, light, heat and discoloration, plasticizers, lubricants and mold release agents, fungistatic and bacteriostatic substances, reinforcing materials and also inorganic and/or organic fillers and mixtures thereof.

Examples of additives are lubricants such as fatty acid esters, their metal soaps, fatty acid amides, fatty acid ester amides and silicone compounds and reinforcing materials such as fibrous reinforcing materials, e.g. inorganic fibers which are produced according to the prior art and may also be treated with a size. Further details regarding the abovementioned auxiliaries and additives may be found in the specialist literature, for example the monograph by J. H. Saunders and K. C. Frisch “High Polymers”, volume XVI, Polyurethane, parts 1 and 2, Interscience Publishers 1962 and 1964, the Taschenbuch für Kunststoff-Additive by R. Gächter and H. Müller (Hanser Verlag Munich 1990) or DE-A 29 01 774.

Suitable catalysts are the tertiary amines known from and customary in the prior art, e.g. triethylamine, dimethylcyclohexylamine, N-methylmorpholine, N,N′-dimethylpiperazine, 2-(dimethylaminoethoxy)-ethanol, diazabicyclo[2.2.2]octane and the like and also, in particular, organic metal compounds such as titanic esters, iron compounds or tin compounds such as tin diacetate, tin dioctoate, tin dilaurate or the dialkyltin salts of aliphatic carboxylic acids, e.g. dibutyltin diacetate or dibutyltin dilaurate or the like. Preferred catalysts are organic metal compounds, in particular titanic esters, iron compounds and tin compounds. The total amount of catalysts in the TPUs used is generally from about 0 to 5% by weight, preferably from 0 to 2% by weight, based on the total amount of TPU.

### Production of the Composition

The abovementioned thermoplastic polyurethanes are usually in pellet form after they have been produced and are processed further together with pulverulent additives to give a powder. These additives serve, inter alia, as fluidizers for improving powder flow and for improving film formation or degassing of the melt layer during the sintering process and are added in an amount of from 0.02 to 0.5% by weight to the TPU. The fluidizer is usually a powdered inorganic substance, with at least 90% by weight of the fluidizer having a particle diameter of less than 25 μm and the substance preferably being selected from the group consisting of hydrated silicon dioxides, hydrophobicized pyrogenic silicas, amorphous aluminum oxide, vitreous silicon dioxides, vitreous phosphates, vitreous borates, vitreous oxides, titanium dioxide, talc, mica, pyrogenic silicon dioxides, kaolin, attapulgite, calcium silicates, aluminum oxide and magnesium silicates.

The comminution of the TPU pellets produced can be carried out together with the fluidizer powder, preferably mechanically at very low temperature (cryogenic comminution). Here, the granules are deep-frozen by use of liquid nitrogen or liquid air and comminuted in pin mills. The particle size is set by means of a sieving machine arranged downstream of the mill. At least 90% by weight of the composition should have a diameter of less than 0.25 mm, preferably less than 0.2 mm, particularly preferably less than 0.15 mm.

The invention will be illustrated with the aid of the following examples.

### EXAMPLES

### Example 1

The TPU (thermoplastic polyurethane) was produced from 1 mol of polyester diol which had a number average molecular weight of about 900 g/mol and was based on about 56.7% by weight of adipic acid and about 43.3% by weight of 1,4-butanediol and also about 1.45 mol of 1,4-butanediol, about 0.22 mol of 1,6-hexanediol, about 2.67 mol of technical-grade diphenylmethane 4,4′-diisocyanate (MDI) containing >98% by weight of 4,4′-MDI, 0.05% by weight of Irganox® 1010 (pentaerythritol tetrakis(3-(3,5-di-tert-butyl-4-hydroxyphenyl)propionate) from BASF SE), 1.1% by weight of Licowax® E (montanic ester from Clariant) and 250 ppm of tin dioctoate by the known static mixer-extruder process.

### Example 2

The TPU was produced from 1 mol of polyesterdiol which had a number average molecular weight of about 900 g/mol and was based on about 56.7% by weight of adipic acid and about 43.3% by weight of 1,4-butanediol and also about 0.85 mol of 1,4-butanediol, about 0.08 mol of 1,6-hexanediol, about 1.93 mol of technical-grade diphenylmethane 4,4′-diisocyanate (MDI) containing >98% by weight of 4,4′-MDI, 0.05% by weight of Irganox® 1010 (pentaerythritol tetrakis(3-(3,5-di-tert-butyl-4-hydroxyphenyl)propionate) from BASF SE), 0.75% by weight of Licowax® E (montanic ester from Clariant) and 250 ppm of tin dioctoate by the known static mixer-extruder process.

0.2% by weight, based on TPU, of hydrophobicized pyrogenic silica was added as fluidizer (Aerosil® R972 from Evonik) to the TPUs produced in Example 1 and 2 and the mixture was processed mechanically at very low temperature (cryogenic comminution) in a pin mill to give powder and subsequently classified by means of a sieving machine. 90% by weight of the composition had a particle diameter of less than 140 μm (measured by means of laser light scattering (HELOS particle size analysis)).

### Comparative Example 3

The TPU (thermoplastic polyurethane) was produced from 1 mol of polyester diol consisting of a 50/50 mixture of an ester which had a number average molecular weight of about 2250 g/mol and was based on about 59.7% by weight of adipic acid and about 40.3% by weight of 1,4-butanediol and an ester which had a number average molecular weight of about 2000 g/mol and was based on about 66.1% by weight of adipic acid, 19.9% by weight of ethylene glycol and 14% by weight of butanediol and also about 2.8 mol of 1,4-butanediol, about 3.8 mol of technical-grade diphenylmethane 4,4′-diisocyanate (MDI) containing >98% by weight of 4,4′-MDI, 0.1% by weight of Irganox® 1010 (pentaerythritol tetrakis(3-(3,5-di-tert-butyl-4-hydroxyphenyl)propionate) from BASF SE), 0.4% by weight of Licolub FA6 (stearoyl ethylenediamide from Clariant), 0.6% by weight of silicone oil M350, 0.2% by weight of Stabaxol I LF (monomeric carbodiimide from Rhein Chemie) and 5 ppm of Tyzor AA105 (titanium acetylacetonate from Dorf Ketal Speciality Catalysts) by the known soft segment preextension process.

The TPU was processed together with 0.2% by weight, based on TPU, of hydrophobicized pyrogenic silica as fluidizer (Aerosil® R972 from Evonik) in a manner analogous to example 1 and 2 at very low temperature (cryogenic comminution) in a pin mill to give powder and subsequently classified by means of a sieving machine. About 90% by weight of the composition had a particle diameter of less than about 150 μm (measured by means of laser light scattering (HELOS particle size analysis)).

### Comparative Example 4

The TPU (thermoplastic polyurethane) was produced from 1 mol of polyester diol which had a number average molecular weight of about 2250 g/mol and was based on about 59.7% by weight of adipic acid and about 40.3% by weight of 1,4-butanediol and also about 3.9 mol of 1,4-butanediol, about 4.9 mol of technical grade diphenylmethane 4.4′-diisocyanate (MDI) containing >98% by weight of 4,4′-MDI, 0.05% by weight of Irganox® 1010 (pentaerythritol tetrakis(3-(3,5-di-tert-butyl-4-hydroxyphenyl)propionate) from BASF SE), 0.2% by weight of Loxamid 3324 (N,N′-ethylenebis-stearylamide from Emery Oleochemicals), 0.2% by weight of Stabaxol I LF (monomeric carbodiimide from Rhein Chemie) and 10 ppm of Tyzor AA105 (titanium acetylacetonate from Dorf Ketal Speciality Catalysts) by the known prepolymer process. The TPU was processed together with 0.2% by weight, based on TPU, of hydrophobicized pyrogenic silica as fluidizer (Aerosil® R972 from Evonik) in a manner analogous to example 1 and 2 at very low temperature (cryogenic comminution) in a pin mill to give powder and subsequently classified by means of a sieving machine. About 90% by weight of the composition had a particle diameter of less than about 150 μm (measured by means of laser light scattering (HELOS particle size analysis)).

### Comparison 5

The values from example 1 of U.S. Pat. No. 8,114,334 B2 have been entered as comparative values in table 3.

### Comparison 6

The values from the comparative example of U.S. Pat. No. 8,114,334 B2 have been entered as comparative values in table 3.

TABLE 1
Properties of the TPUs produced

| | | Comparative | Comparative | Example | Example |
|---|---|---|---|---|---|
| | | example 3 | example 4 | 1 | 2 |
| Melting range* | [from C° to | 100-210 | 100-200 | 80-170 | 80-155 |
| | ° C.] | | | | |
| Hardness | [Shore A] | 86 | 90 | 90 | 70 |

Characterization of the melting behavior via the MVR** at various temperatures

| | | | | | |
|---|---|---|---|---|---|
| T_{X} | [° C.] | 200° C. | 200° C. | 160 | 150 |
| MVR at T_{X} | [cm³/10 min] | 5 | 13 | 15 | 13 |
| MVR at T_{X+10} | [cm³/10 min] | 130 | 138 | 31 | 26 |
| MVR at T_{X+20} | [cm³/10 min] | too high [>200], | too high [>200], | 53 | 40 |
| | | no longer | no longer | | |
| | | measurable | measurable | | |
| Suitability*** | | no | no | yes | yes |

*DSC 2nd heating 5K/min
**The MVR measurements were carried out in accordance with ISO 1133.
***Suitability as raw material for use in powder-based additive manufacturing processes

The powders produced were processed by means of a commercial laser sintering machine from the manufacturer EOS GmbH, series EOS P360 to give test specimens. The processing parameters during laser sintering are given in table 2.

TABLE 2
Processing parameters in the production of the test specimens by laser sintering from the
compositions produced

| | | Composition | Composition | Composition | Composition |
|---|---|---|---|---|---|
| | | from | from | from | from |
| | | Example 1 | Example 2 | comparison 3 | comparison 4 |
| Laser energy | [W] | 40 | 40 | 40 | 40 |
| Building space temperature | [° C.] | 95 | 75 | 95 | 95 |
| Linear distance of laser | [mm] | 0.2 | 0.13 | 0.2 | 0.2 |
| Laser speed | [mm/s] | 4000 | 6000 | 4000 | 4000 |
| Powder layer thickness | [mm] | 0.15 | 0.15 | 0.15 | 0.15 |

TABLE 3
Comparison of the mechanical properties of the compositions of the
invention with known compositions

| | | Composition | Composition | Composition | Composition |
|---|---|---|---|---|---|
| | | comprising | comprising | as per | as per |
| | | TPU powder | TPU powder | example 1 of | comparison of |
| | | as per | as per | US 8114334 | US 8114334 |
| | | example 1 | example 2 | B2 | B2 |
| Hardness* | [Shore A] | 90 | 70 | 55-65 | 75 |
| Ultimate | [MPa] | 18 | 12.5 | 2.7 | 1.0 |
| tensile | | | | | |
| strength** | | | | | |
| Elongation at | [MPa] | 489 | 479 | 170 | 115 |
| break** | | | | | |
| Density | [g/cm³] | 1.19 | 1.01 | | |

*The hardness measurement was carried out in accordance with DIN ISO 7619-1.
**The determination of the mechanical properties (ultimate tensile strength, elongation at break) was carried out in accordance with DIN 53504.

In the DSC measurement, the material was subject to the following temperature cycle: 1 minute at minus 60° C., then heating to 200° C. at 5 kelvin/minute, then cooling to minus 60° C. at 5 kelvin/minute, then 1 minute at minus 60° C., then heating to 200° C. at 5 kelvin/minute.

Comparative examples 3 and 4 show that not every thermoplastic polyurethane is suitable for producing compositions for powder-based additive manufacturing processes. When processed by laser sintering, they do not display any selective melting of the regions which are heated by the laser, so that no satisfactory reproduction accuracy is obtained. The component geometry of the test specimens produced from these compositions is unsatisfactory, and it was therefore not possible to produce test specimens which were usable for further analyses. Only when using the flat-melting materials from example 1 and 2 is precise selective melting of the composition possible, as a result of which good reproduction accuracy combined with high density and good mechanical properties is obtained (see table 1 and 3). Compared to the systems known from the literature, an excellent level of mechanical properties is attained when using the compositions described in example 1 and 2, which is shown by high ultimate tensile strengths and high elongations at break.

1. A thermoplastic pulverulent composition comprising:
from 0.02 to 0.5% by weight, based on the total weight of the composition, of plasticizers; and
pulverulent thermoplastic polyurethane, where at least 90% by weight of the composition has a particle diameter of less than 0.25 mm;
wherein the thermoplastic polyurethane comprises a reaction product of the components comprising:
a) at least one organic diisocyanate;
b) at least one compound having groups which are reactive toward isocyanate groups and a number average molecular weight (Mn) of from 500 g/mol to 6000 g/mol and a number average functionality of the totality of the components under b) of from 1.8 to 2.5; and
c) at least one chain extender having a molecular weight (Mn) of from 60 to 450 g/mol and a number average functionality of the totality of the chain extenders under c) of from 1.8 to 2.5; in the presence of
wherein the thermoplastic polyurethane has:
a melting range (DSC, differential scanning calorimetry; 2nd heating at a heating rate of 5 K/min.) of from 20° C. to 170° C.; and
a Shore A hardness (DIN ISO 7619-1) of from 50 to 95; and
a melt volume rate (MVR), measured in accordance with ISO 1133 at a temperature T, of from 5 to 15 cm³/10 min, and a change in the MVR when increasing the temperature T by 20° C. of less than 90 cm³/10 min,
for producing articles in powder-based additive manufacturing processes.

2. A process for producing a thermoplastic object, the process comprising conducting an additive manufacturing process with the composition as claimed in claim 1.

3. A thermoplastic object produced by the process of claim 2.

4. The thermoplastic pulverulent composition of claim 1, wherein the thermoplastic polyurethane comprises a reaction product of components comprising a), b), and c) in the presence of a catalyst.

5. The thermoplastic pulverulent composition of claim 1, wherein the thermoplastic polyurethane comprises a reaction product of components comprising of a), b), and c) in the presence of one or more auxiliaries and/or additives.

6. The thermoplastic pulverulent composition of claim 1, wherein the thermoplastic polyurethane comprises a reaction product of components comprising a), b), and c) in the presence of one or more chain termination agents.

7. The thermoplastic pulverulent composition of claim 4, wherein the thermoplastic polyurethane comprises a reaction product of components comprising a), b), and c) in the presence of one or more auxiliaries and/or additives.

8. The thermoplastic pulverulent composition of claim 4, wherein the thermoplastic polyurethane comprises a reaction product of components comprising a), b), and c) in the presence of one or more chain termination agents.

9. The thermoplastic pulverulent composition of claim 7, wherein the thermoplastic polyurethane comprises a reaction product of components comprising a), b), and c) in the presence of one or more chain termination agents.
